(19) United States
(12) Patent Application Publication
(10) Pub. No.: US 2013/0078296 A1
(43) Pub. Date: Mar. 28, 2013

(54) COMPOSITION AND METHOD OF TIME RELEASING ESSENTIAL OILS FOR ANIMAL REPELLENCY AND PESTICIDE USE

(71) Applicant: Liquid Holding Company, Inc., Broadheadsville, PA (US)

(72) Inventors: Paul Grlica, Pocono Lake, PA (US); Steve Wisdom, Sterrett, AL (US)

(73) Assignee: LIQUID HOLDING COMPANY, INC., Broadheadsville, PA (US)

(21) Appl. No.: 13/682,043

(22) Filed: Nov. 20, 2012

Related U.S. Application Data
(63) Continuation of application No. 12/806,399, filed on Aug. 11, 2010, now abandoned.

(51) Int. Cl. A01N 25/00; A01N 65/18

(52) U.S. Cl. CPC A01N 25/00; A01N 65/18
USPC 424/405; 424/731

(57) ABSTRACT

The invention is a method of releasing essential oils over at least 30 days which includes encapsulating one or more essential oils in one or more carbohydrate and one or more protein. Additional embodiments include pesticides and/or additional repellents.

### BACKGROUND OF THE INVENTION

Moles, voles, gophers and other burrowing animals can wreak havoc on lawns and gardens. Numerous products in the prior art have been developed to repel these burrowing animals with only moderate success. While the prior art recognizes that essential oils may be a repellent for moles, voles and gophers, the problem is that when essential oils are administered in the prior art, they are only effective for a very limited time. Snakes and other reptiles, insects, birds and mammals may also be undesirable on lawns and gardens and in other areas which are frequented by humans and/or their pets. Again, repellents are needed which last over a period of time.

Snakes, rodents, insects and other animals also invade areas which are frequented by humans and their pets or are used for storage for edible items. Pesticides and repellents are used in these areas in the prior art but there is a need for longer lasting pesticide and repellent products.

In the prior art, certain materials were used as repellents, such as those in U.S. Pat. No. 6,753,004. However, the time period over which the repellents were effective was minimal.

### SUMMARY OF THE INVENTION

The present invention solves the prior art problem with a composition and method for encapsulating essential oils for release over time. One embodiment used the encapsulated essential oils for repelling animals. One embodiment of the invention is a composition comprising one or more essential oils which are at least partially, preferably totally, encapsulated in one or more encapsulating materials. The encapsulation causes the essential oils to be gradually released over a period of at least 30 days or more.

Another embodiment of the invention is a method for releasing essential oils over a time of at least 30 days or more by encapsulating one or more essential oils in one or more encapsulating materials.

Another embodiment of the invention is a method of repelling animals comprising placing one or more bait in a path of one or more animal for at least 24 hours, wherein the bait comprises one or more essential oils and one or more encapsulating materials, wherein the encapsulating material encapsulates at least one essential oil, and wherein the bait automatically releases the essential oils over at least 30 days or more.

Another embodiment of the invention is a method of killing animals comprising placing one or more bait in a path of one or more animal for at least 30 days or more, wherein the bait comprises one or more essential oils, one or more pesticide and one or more encapsulating materials, wherein the encapsulating material encapsulates at least one essential oil, and wherein the bait automatically releases the essential oils and pesticide over at least 30 days or more.

### DETAILED DESCRIPTION OF THE INVENTION

“Essential oil” is defined as a concentrated, hydrophobic liquid containing volatile aroma compounds from plants. Essential oils carry a distinctive scent of the plant. Examples of essential oils include, without limitation, oils of castor, agar, ajwain, angelica root, anise, asafoetida, balsam, basil, bergamot, bay, black pepper, buchu, birch, camphor, cannabis flower, caraway, cardamom, carrot seed, cedarwood, chamomile, calamus root, cinnamon, cistus species, citronella, clary sage, clove leaf, coffee, coriander, costmary, costus root, cranberry seed, cubeb, cumin, cypress, cypriol, curry leaf, davana, dill, elecampane, eucalyptus, fennel seed, fenugreek, fir, frankincense, galangal, galbanum, geranium, ginger, goldenrod, grapefruit, henna, helichrysum, hyssop, idaho tansy, jasmine, juniper berry, lavender, laurus nobilis, ledum, lemon, lemongrass, litsea cubeba, majoram, melaleuca, melissa (lemon balm), mentha arvensis, mountain savory, mugwort, mustard, myrrh, myrtle, neem tree, neroli, nutmeg, orange, oregano, orris, palo santo, parsley, patchouli, perilla, pennroyal, peppermint, petitgain, pine, ravensara, red cedar, roman chamomile, rose, rosehip, rosemary, rosewood, sage, star anise, sandalwood, sassafras, savory, schisandra, spearmint, spikenard, spruce, tangerine, tarragon, tea tree, thyme, tsuga, turmeric, valerian, vetiver, western red cedar, wintergreen, yarrow, ylang-ylang, zeodary and parts thereof.

“Animals” include mammals, reptiles, birds and insects.

“Encapsulating materials” are defined as certain carbohydrates and certain proteins.

Examples of encapsulating materials include, without limitation, carbohydrates such as without limitation, gelatin; monosaccharides; disaccharides; polysaccharides; glucose; fructose; sucrose; lactose; maltose; cellobiose; glycerol; starches including without limitation corn starch, wheat starch, rice starch, potato starch; water-soluble gums including without limitations carob gum, xanthan gum, carrageenan, guar gum, locust bean gum, arabinogalactans, gum Arabic, agar, and pectin; and natural proteins such as without limitation casein, whey protein, gelatin, gluten, soy protein, and albumin. It is preferable that the encapsulating material include at least one listed carbohydrate and at least one listed protein.

“Natural” means materials occurring in nature, as well as man-made or synthesized materials identical to materials occurring in nature.

“Pesticide” is defined as any composition which is effective at killing a specified animal. One of ordinary skill in the art would be familiar with numerous pesticides for use against a specified animal.

Preferably, the encapsulating material comprises at least one carbohydrate polymer, at least one sodium, and at least one protein; in which the percentage content of sodium, carbohydrate polymer, and protein components range from about 50%-90%, about 2%-15%, and about 15%-40%, respectively, on a solids basis. All percentages in this specification are weight percentages unless otherwise noted.

In other preferred embodiments, the encapsulating material comprises natural sugar, natural carbohydrate polymer, and natural protein components in the ranges of about 50%-90%, about 5%-15%, and about 15%-30%, respectively, on a solids basis.

One example embodiment has encapsulating material of a blend of water, sodium, gelatin, polysaccharide, starch, potassium sorbate, locust bean gum, a preservative and a food coloring.

Another embodiment has encapsulating material of sucrose, gelatin, glycerol, Kappa carrageenan, potassium chloride, and potassium sorbate, a preservative and a food coloring.

Another embodiment of encapsulating material includes a blend of water, sucrose, gelatin agar, calcium chloride, starch, corn syrup, glycerin and food coloring.

Another embodiment of encapsulating material includes a blend of sucrose, gelatin, sodium alginate, locust bean gum, calcium chloride, starch, corn syrup, glycerin, sodium benzoate and sodium metaphosphate.

Another embodiment of encapsulating material includes a blend of sucrose, gelatin, sodium alginate, calcium chloride, starch, sodium metaphosphate, corn syrup, glycerin and food coloring.

One embodiment of the invention is a composition which is made to look like a worm. The composition comprises one or more essential oils encapsulated at least partially, preferably totally, in one or more encapsulating materials. Additionally the composition comprises edible materials which are desirable for a specific animal (for example food for moles if moles are the animal to be repelled). Food Source Lure Corp. of Birmingham, Ala. produces such “worms” without the encapsulated essential oils.

One embodiment for repelling moles is a composition comprising castor oil, corn starch, sugar, water, carob gum (locust bean gum), gelatins, sorbitol, sorbic acid potassium salt, benzoic acid sodium salt and iron oxide. This composition is preferably formed to look like a worm.

In other embodiments, it may be desirable to add additional components to the compositions, such as plant fertilizers, plant growth stimulants, repellents for other animals, repellents for insects, colorants, preservatives, dyes, and perfumes.

One embodiment for repelling moles is a composition comprising 35% castor oil, and then 65% of the following ingredients: corn starch, sugar, water, carob gum (locust bean gum), gelatins, sorbitol, sorbic acid potassium salt, benzoic acid sodium salt and iron oxide. This composition is formed to look like a worm. The worm-like composition is placed (preferably without being touched by a human) in mole tunnels. The moles then eat at least some of the worm-like composition and have digestive problems and avoid the tunnel in the future. The worm-like composition continues to have the desired effect of repellency for at least 30 days or more while the essential oils are gradually released from the encapsulating materials.

Other embodiments of the invention include other repellents and/or pesticides which are encapsulated in one or more of the encapsulating materials.

### Test 1

In this test, repellency of Eastern mole (Scalopus aquaticus) was evaluated in a 500 square foot ground surface with mole tunnels. The areas were tested with earthworm scented “worms”, unscented “worms”, 10% castor oil earthworm scented “worms”, 10% castor oil unscented “worms”, 35% castor oil earthworm scented “worms” and 35% castor oil unscented “worms.” The “worms” were provided by Food Source Lure Corp. of Birmingham, AL. The “worms” were comprised of the following materials:

Ingredient Table

| Ingredient | Weight Percent |
|---|---|
| Mint Oil | 5.92 |
| Sodium Lauryl Sulfate | 2.96 |
| Thyme Oil white | 1.93 |
| Putrescent egg solids | 1.48 |
| potassium sorbate | 0.14 |
| water | 42.76 |
| gelatin | 13.5 |
| corn starch | 15.3 |
| wheat flour | 9.4 |
| sorbic acid potassium salt | 3.2 |
| iron oxide | 1 |
| lime | 1.44 |
| sodium benzoate | 0.53 |
| Guar gum | 0.44 |

The “worms” were then treated with the appropriate amount of castor oil.

One week prior to starting the test, the mole tunnels were walked over and rolled with a lawn roller to flatten tunnels back to surrounding ground levels. After 7 days, the site was visually observed for new tunneling activity. New active tunnels were measured in linear feet and outlined with landscape marking paint prior to the addition of the “worms” into the tunnels. Then, the tunnels were again flattened back to the surrounding ground level and monitored at the selected intervals for re-occurrence of mole activity in the tunnels.

The first area was prepared as follows (results are in Table 1 and Graphs 1-2). A paper clip was secured into ⅓ of the length of the “worms” and exited to form a hook to prevent “worm” removal from the paper clips. The opposing end of the paper clip was secured to a 3″ by 4″ piece of ¼″ thick plywood, suspending the “worm” beneath the plywood. The tunnels were opened every 5 or 10 feet with a spoon and a “worm” lowered in the tunnel. The openings were recovered with the soil and plywood. The plywood strips were removed at the 7 day after treatment (“DAT”) due to wind lifting the plywood and worms being pulled from the clips when the plywood was lifted by the wind or observations. A 3″ vinyl marker flag was threaded through the paper clip attached to the “worm” and secured into the sod surrounding the treatment locations.

The second test area (see Table 2) was prepared as follows. A paper clip was secured into ⅓ of the length of the “worms” and exited to form a hook to prevent “worm” removal from the paper clips. The tunnels were opened every 5 or 10 feet with a spoon and the “worms” were lowered into the tunnels. The openings were recovered with the soil. A vinyl marker flag was threaded through the paperclip attached to the “worms” and secured into the sod surrounding the treatment locations.

The third and fourth test areas were area repellencies (not individual tunnels) to determine whether the tunnels moved away from the areas treated with the “worms.” 500 sq. ft. plots were measured and marked with a one-foot overspray area around each plot where observations would not occur.

The third area (see Table 3) had the tunnels treated the same as the second area.

The fourth area (see Table 4) had “worms” dropped into the holes in the tunnels at 5 feet intervals and covered with soil. These tunnels were not opened again and the “worm” condition was not evaluated.

Tables 1-2 show the average reduction in tunnel footage after applications of the ^{“}worms”. Tables 3 and 4 show each individual replicates of “worms” with the average % tunnel reductions calculated in the tables.

As seen in the tables, 10% castor oil and 35% castor oil scented and unscented “worms” have the ability to provide repellency for approximately 3 weeks. “DAT” means days after treatment.

TABLE 1
Average % Reduction in Tunnel Footage Produced by Eastern
Moles (Scalopus aquaticus) After Introduction of
“Worms” (Average of 2 Replicates per Treatment)

| | Pre-Treatment | | | | | |
|---|---|---|---|---|---|---|
| | | Ave # | Post-Treatment | | | |
| | Ave | Worms | Ave % Tunnel Reduction | | | |
| | Tunnel | per | 7 | 14 | 21 | 28 |
| Treatments: | Footage | Tunnel | DAT | DAT | DAT | DAT |
| 0% oil/scented @ 5′ | 14 | 3 | 0% | 4% | 0% | 0% |
| 0% oil/unscented @ 5′ | 12.5 | 2.5 | 95% | 70% | 30% | 17% |
| 10% oil/scented @5′ | 14.5 | 3 | 76% | 86% | 62% | 17% |
| 10% oil/unscented @ | 12.5 | 2.5 | 9% | 32% | 49% | 6% |
| 5′ | | | | | | |
| 35% oil/scented @ 5′ | 16.5 | 3.5 | 74% | 88% | 78% | 16% |
| 35% oil/unscented @ | 12.5 | 2.5 | 85% | 73% | 33% | 12% |
| 5′ | | | | | | |
| 10% oil/scented @ 10′ | 16.5 | 2 | 19% | 18% | 12% | 11% |
| 10% oil/unscented @ | 13.5 | 1.5 | 100% | 81% | 42% | 21% |
| 10′ | | | | | | |
| 35% oil/scented @ 10′ | 22.5 | 2.5 | 57% | 57% | 39% | 17% |
| 35% oil/unscented @ | 21.5 | 2.5 | 79% | 65% | 45% | 14% |
| 10′ | | | | | | |

TABLE 2
Average % Reduction in Tunnel Footage Produced by Eastern
Moles (Scalopus aquaticus) After Introduction of
“Worms” (Average of 2 Replicates per Treatment)

| | Pre-Treatment | | | | | |
|---|---|---|---|---|---|---|
| | | Ave # | Post-Treatment | | | |
| | Ave | Worms | Ave % Tunnel Reduction | | | |
| | Tunnel | per | 7 | 14 | 21 | 28 |
| Treatments: | Footage | Tunnel | DAT | DAT | DAT | DAT |
| 0% oil/scented @ 5′ | 14 | 3 | 0% | 4% | 0% | 0% |
| 0% oil/unscented @ 5′ | 12.5 | 2.5 | 95% | 70% | 30% | 17% |
| 10% oil/scented @ 5′ | 14.5 | 3 | 76% | 86% | 62% | 17% |
| 10% oil/unscented @ | 12.5 | 2.5 | 9% | 32% | 49% | 6% |
| 5′ | | | | | | |
| 35% oil/scented @ 5′ | 16.5 | 3.5 | 74% | 88% | 78% | 16% |
| 35% oil/unscented @ | 12.5 | 2.5 | 85% | 73% | 33% | 12% |
| 5′ | | | | | | |
| 10% oil/scented @ 10′ | 16.5 | 2 | 19% | 18% | 12% | 11% |
| 10% oil/unscented @ | 13.5 | 1.5 | 100% | 81% | 42% | 21% |
| 10′ | | | | | | |
| 35% oil/scented @ 10′ | 22.5 | 2.5 | 57% | 57% | 39% | 17% |
| 35% oil/unscented @ | 21.5 | 2.5 | 79% | 65% | 45% | 14% |
| 10′ | | | | | | |

TABLE 3
Average % Reduction in Tunnel Footage Produced by Eastern Moles (Scalopus aquaticus)
After Introduction of “Worms” (Average of 4-5 Replicates per Treatment)

| | Pre-Treatment | | | | | | |
|---|---|---|---|---|---|---|---|
| | | Ave # | Post-Treatment | | | | |
| | Ave | Worms | Ave % Tunnel Reduction | | | | |
| | Tunnel | per | 7 | 14 | 21 | 28 | 35 |
| Treatments: | Footage | Tunnel | DAT | DAT | DAT | DAT | DAT |
| Control | 20 | | 80% | 35% | 100% | 100% | 100% |
| Control | 15 | | 53% | 20% | 53% | 13% | 100% |
| Control | 30 | | 100% | 77% | ** ** 73% | 87% | 100% |
| Control | 31 | | 77% | 13% | 58% | 45% | 100% |
| Control | 12 | | 100% | 100% | 100% | 100% | 100% |
| Control Ave | 21.6 | 0 | 82% | 49% | 77% | 69% | 100% |
| 35% worm @ 5′ | 18 | 3 | 100% | *** 67% | 100% | 100% | 100% |
| 35% worm @ 5′ | 16 | 3 | 100% | 100% | 100% | 0% | 100% |
| 35% worm @ 5′ | 36 | 7 | * 78% | **** 25% | 75% | 53% | 100% |
| 35% worm @ 5′ | 18 | 5 | ** 0% | 6% | 67% | 0% | 50% |
| 35% Worm Ave | 22 | 4.5 | 69% | 49% | 85% | 38% | 88% |

* = Moved from original tunnel and re-treated with 2 worms
** = Moved from original tunnel and re-treated with 5 worms
*** = Returned to original tunnel
**** = 11′ in overspray area
** ** = New tunnels

TABLE 4
Average % Reduction in Tunnel Footage Produced by Eastern
Moles (Scalop [symbol] aquaticus) After Introduction
of “Worms” (Average of 4-6 Replicates per Treatment)

| | Pre-Treatment | | | | | |
|---|---|---|---|---|---|---|
| | | Ave # | Post-Treatment | | | |
| | Ave | Wor [symbol] | Ave % Tunnel Reduction | | | |
| | Tunn [symbol] | per | 7 | 14 | 21 | 28 |
| Treatments: | Footage | Tunnel | DA [symbol] | DA [symbol] | DA [symbol] | DA [symbol] |
| Control | 37 | | 0% | 0% | 0% | 0% |
| Control | 18 | | 0% | 17% | 0% | 0% |
| Control | 18 | | 0% | 0% | 0% | 0% |
| Control | 46 | | 0% | 0% | 0% | 0% |
| Control Ave | 30 | 0 | 0% | 4% | 0% | 0% |
| 5″ Castor Oil Plastic | 18 | 3 | 39% | 39% | 28% | 44% |
| Worms | | | | | | |
| 5″ Castor Oil Plastic | 43 | 8 | 0% | 0% | 0% | 0% |
| Worms | | | | | | |
| 5″ Castor Oil Plastic | 22 | 5 | 0% | 0% | 0% | 0% |
| Worms | | | | | | |
| 5″ Castor Oil Plastic | 22 | 4 | 5% | 0% | 0% | 9% |
| Worms | | | | | | |
| 5″ Castor Oil Plastic | 64 | 12 | 8% | 72% | 75% | 66% |
| Worms | | | | | | |
| 5″ Castor Oil Plastic | 41 | 8 | 0% | 0% | 0% | 0% |
| Worms | | | | | | |
| 5″ Castor Oil Worm Ave | 35 | 7 | 9% | 18% | 17% | 20% |

[symbol]

indicates data missing or illegible when filed

### Test 2.

The same product as was tested in Test 1 was tested for snake repellants. In this test, a screen cage (27″W×93″L inside dimensions) was used as the test arena. A mesh screen allowed for air flow and limited stagnation inside the cage. Harborage Panels were fitted inside the screen cage and covered treated areas: 24″W×22″W×1.5″H. An acclimation Chamber (16.5″ H×6″ Dia. PVC with (4) 1.5″×4″ screen air flow slots) had an attached rope pulley system, which was used to introduce snakes into the cage and allow them to acclimate to the cage conditions for 15 minutes prior to testing.

Test products were applied to a landscape cloth. For landscape cloth areas, (1) plywood sheet was covered with plastic sheeting (to prevent test products from absorbing into the plywood), then the landscape cloth was placed on top of the plastic sheeting and covered with the screen cage. The landscape cloth consisted of two 4′ sections of cloth, taped together in the center of the cage. A piece of tape was added to each side of the cage, 25 inches from the end of the cage. After the addition of tape, the cage was divided into three portions: near, middle, and far. The Screen Cage had 2 Harborage Panels placed at each inside end of the cage. The Harborage Panels provide a harborage area for many species, wherein they prefer to spend their time under the panel during testing.

A video recording device was used to record snake activity with limited human interaction during testing. Individual snakes were replicated by species and 2-3 replications of treatments were conducted. Snakes in the process of shedding were not used for testing.

Each snake was placed and sealed in the Acclimation Chamber in the center of the Screen Cage. Each snake was allowed a 15 minute acclimation period inside the Acclimation Chamber prior to the start of the control period. After the 15 minute acclimation, the Video Recorder was activated and the Acclimation Chamber was removed (pulled up and secured with the pulley system from outside the test room).

The snakes were left undisturbed for a 1 hour control period in the Screen Cage.

Following the control period, the snake was removed from the Screen Cage and held back in the rearing container while the control video was reviewed. Once the preferred location of the cage was determined by watching the control period video, the preferred location was treated with the test product (40.9 grams). Then 40.9 grams of the control pellets were applied to the opposing location (70.2 grams of control pellets were applied in between locations to maintain a consistent texture through the entire floor). There were 11 lb/50 sq. ft. and the pellets were evenly sprinkled over the floor.

Then, the snake was placed in the sealed Acclimation Chamber for a 15 minute acclimation period. Each control test and treatment test lasted 1 hour in 84° F. (average) and 57% average humidity.

Then, the video recorder was activated and the snake was exposed to the treated cage.

Data was recorded from reviewing the video including: (1) The amount of time each snake spent on each side or under each panel. (2)The level of activity on each side or under the Harborage Panels was compared between the treatment periods and the untreated control periods. (3)% Repellency=1−(# of minutes on treated side/# of minutes on untreated side)×100. (4)When the snakes did not move after the Acclimation Chamber was lifted; the tests were not valid and were replicated again.

The following adult snakes were tested: Black Rat Snake (Elaphe obsoleta) (2 replicates), Grey Rat (Elaphe obsoleta spiloides) (2 replicates), Gopher Pine (Pituophis catenifer melanoleucus) (3 replicates), and Corn Snake (Elaphe Guttata) (3 replicates).

TABLE 5
Average % Repellency of Liquid Fence II-Snake 4 in a Divided
Arena When Test Against Black Rat Snakes (Elaphe obsoleta)

| | | | % Time | % Time | % | % | |
|---|---|---|---|---|---|---|---|
| | | | in Front | in Front | Repelled | Repelled | |
| | Snake | | Control | Treatment | if Front | if Back | % |
| Treatment | Species | Location | Period | Period | Treated | Treated | Repelled |
| Liquid Fence | Black Rat | Front | 68.09 | 53.19 | 22% | 0% | 22% |
| II - Snake 4 | | | | | | | |
| Liquid Fence | Black Rat | Back | 38.00 | 54.55 | 0% | 27% | 27% |
| II - Snake 4 | | | | | | | |
| Avg % | | | | | | | 24% |
| Repelled | | | | | | | |

TABLE 6
Average % Repellency of Liquid Fence II-Snake 4 in a Divided
Arena When Test Against Corn Snakes (Elaphe Guttata)

| | | | % Time | % Time | % | % | |
|---|---|---|---|---|---|---|---|
| | | | in Front | in Front | Repelled | Repelled | |
| | Snake | | Control | Treatment | if Front | if Back | % |
| Treatment | Species | Location | Period | Period | Treated | Treated | Repelled |
| Liquid | Corn | Front | 50.98 | 37.04 | 27% | 0% | 27% |
| Fence II - | Snake | | | | | | |
| Snake 4 | | | | | | | |
| Liquid | Corn | Front | 55.56 | 0.00 | 100% | 0% | 100% |
| Fence II - | Snake | | | | | | |
| Snake 4 | | | | | | | |
| Liquid | Corn | Back | 48.15 | 55.56 | 0% | 14% | 14% |
| Fence II - | Snake | | | | | | |
| Snake 4 | | | | | | | |
| Avg % | | | | | | | 47% |
| Repelled | | | | | | | |

TABLE 7
Average % Repellency of Liquid Fence II-Snake 4 in a Divided Arena When
Test Against Gopher Pine Snakes (Pituophis catenifer melanoleucus)

| | | | % Time | % Time | % | % | |
|---|---|---|---|---|---|---|---|
| | | | in Front | in Front | Repelled | Repelled | |
| | Snake | | Control | Treatment | if Front | if Back | % |
| Treatment | Species | Location | Period | Period | Treated | Treated | Repelled |
| Liquid | Gopher | Front | 57.89 | 3.64 | 94% | 0% | 94% |
| Fence II - | Pine | | | | | | |
| Snake 4 | | | | | | | |
| Liquid | Gopher | Front | 96.43 | 69.64 | 28% | 0% | 28% |
| Fence II - | Pine | | | | | | |
| Snake 4 | | | | | | | |
| Liquid | Gopher | Back | 31.03 | 100.00 | 0% | 100% | 100% |
| Fence II - | Pine | | | | | | |
| Snake 4 | | | | | | | |
| Avg % | | | | | | | 74% |
| Repelled | | | | | | | |

TABLE 8
Average % Repellency of Liquid Fence II-Snake 4 in a Divided Arena
When Test Against Grey Rat Snakes (Elaphe obsoleta spiloides)

| | | | % Time | % Time | % | % | |
|---|---|---|---|---|---|---|---|
| | | | in Front | in Front | Repelled | Repelled | |
| | Snake | | Control | Treatment | if Front | if Back | % |
| Treatment | Species | Location | Period | Period | Treated | Treated | Repelled |
| Liquid | Grey Rat | Front | 16.98 | 27.66 | 0% | 13% | 13% |
| Fence II - | | | | | | | |
| Snake 4 | | | | | | | |
| Liquid | Grey Rat | Back | 72.550 | 28.30 | 61% | 27% | 61% |
| Fence II - | | | | | | | |
| Snake 4 | | | | | | | |
| Avg % | | | | | | | 37% |
| Repelled | | | | | | | |

It is to be understood that while the invention has been described in conjunction with the detailed description thereof, that the foregoing description is intended to illustrate and not limit the scope of the invention, which is defined by the scope of the appended claims. Other aspects, advantages, and modifications are evident from a review of the following claims.

What is claimed is:

1. A composition comprising one or more essential oils, and one or more encapsulating materials wherein the encapsulating materials at least partially encapsulate at least one essential oil.

2. The composition of claim 1 wherein the essential oils comprise one or more of the group consisting of oils of castor, agar, ajwain, angelica root, anise, asafoetida, balsam, basil, bergamot, bay, black pepper, buchu, birch, camphor, cannabis flower, caraway, cardamom, carrot seed, cedarwood, chamomile, calamus root, cinnamon, cistus species, citronella, clary sage, clove leaf, coffee, coriander, costmary, costus root, cranberry seed, cubeb, cumin, cypress, cypriol, curry leaf, davana, dill, elecampane, eucalyptus, fennel seed, fenugreek, fir, frankincense, galangal, galbanum, geranium, ginger, goldenrod, grapefruit, henna, helichrysum, hyssop, idaho tansy, jasmine, juniper berry, lavender, laurus nobilis, ledum, lemon, lemongrass, litsea cubeba, majoram, melaleuca, melissa (lemon balm), mentha arvensis, mountain savory, mugwort, mustard, myrrh, myrtle, neem tree, neroli, nutmeg, orange, oregano, orris, palo santo, parsley, patchouli, perilla, pennroyal, peppermint, petitgain, pine, ravensara, red cedar, roman chamomile, rose, rosehip, rosemary, rosewood, sage, star anise, sandalwood, sassafras, savory, schisandra, spearmint, spikenard, spruce, tangerine, tarragon, tea tree, thyme, tsuga, turmeric, valerian, vetiver, western red cedar, wintergreen, yarrow, ylang-ylang, zeodary and parts thereof.

3. The composition of claim 1 wherein the essential oils comprise castor oil.

4. The composition of claim 1 wherein the encapsulating materials comprise one or more carbohydrate and one or more protein.

5. The composition of claim 1 wherein the encapsulating materials comprise one or more selected from the group consisting of gelatin; monosaccharides; disaccharides;
polysaccharides; glucose; fructose; sucrose; lactose; maltose; cellobiose; glycerol;
starch, corn starch, wheat starch, rice starch, potato starch; water-soluble gums, carob gum, xanthan gum, carrageenan, guar gum, locust bean gum, arabinogalactans, gum Arabic, agar, and pectin; natural proteins, casein, whey protein, gelatin, gluten, soy protein, and albumin.

6. The composition of claim 1 further comprising one or more pesticides.

7. The composition of claim 1 wherein the composition repels animals.

8. The composition of claim 7 wherein the animals comprise one or more of the group consisting of moles, voles, snakes, chipmunks, gophers, deer, rabbit, geese, dogs, cats, insects, birds, squirrels, other mammals and other reptiles.

9. A method for releasing essential oils over a time comprising encapsulating one or more essential oils in one or more encapsulating materials.

10. The method of claim 9 wherein the essential oils comprise one or more of the group consisting of oils of castor, agar, ajwain, angelica root, anise, asafoetida, balsam, basil, bergamot, bay, black pepper, buchu, birch, camphor, cannabis flower, caraway, cardamom, carrot seed, cedarwood, chamomile, calamus root, cinnamon, cistus species, citronella, clary sage, clove leaf, coffee, coriander, costmary, costus root, cranberry seed, cubeb, cumin, cypress, cypriol, curry leaf, davana, dill, elecampane, eucalyptus, fennel seed, fenugreek, fir, frankincense, galangal, galbanum, geranium, ginger, goldenrod, grapefruit, henna, helichrysum, hyssop, idaho tansy, jasmine, juniper berry, lavender, laurus nobilis, ledum, lemon, lemongrass, litsea cubeba, majoram, melaleuca, melissa (lemon balm), mentha arvensis, mountain savory, mugwort, mustard, myrrh, myrtle, neem tree, neroli, nutmeg, orange, oregano, orris, palo santo, parsley, patchouli, perilla, pennroyal, peppermint, petitgain, pine, ravensara, red cedar, roman chamomile, rose, rosehip, rosemary, rosewood, sage, star anise, sandalwood, sassafras, savory, schisandra, spearmint, spikenard, spruce, tangerine, tarragon, tea tree, thyme, tsuga, turmeric, valerian, vetiver, western red cedar, wintergreen, yarrow, ylang-ylang, zeodary and parts thereof.

11. The method of claim 9 wherein the essential oils comprise castor oil.

12. The method of claim 9 wherein the encapsulating materials comprise one or more carbohydrate and one or more protein.

13. The method of claim 9 wherein the encapsulating materials comprise one or more selected from the group consisting of gelatin; monosaccharides; disaccharides; polysaccharides; glucose; fructose; sucrose; lactose; maltose; cellobiose; glycerol; starch, corn starch, wheat starch, rice starch, potato starch; water-soluble gums, carob gum, xanthan gum, carrageenan, guar gum, locust bean gum, arabinogalactans, gum Arabic, agar, and pectin; natural proteins, casein, whey protein, gelatin, gluten, soy protein, and albumin.

14. The method of claim 9 further comprising encapsulating one or more pesticides.

15. A method of repelling animals comprising placing one or more bait in a path of one or more animal for at least 30 days, wherein the bait comprises one or more essential oils and one or more encapsulating materials, wherein the encapsulating material encapsulates at least one essential oil, and wherein the bait automatically releases the essential oils over at least a 30 day period.

16. The method of claim 15 wherein the essential oils comprise one or more of the group consisting of oils of castor, agar, ajwain, angelica root, anise, asafoetida, balsam, basil, bergamot, bay, black pepper, buchu, birch, camphor, cannabis flower, caraway, cardamom, carrot seed, cedarwood, chamomile, calamus root, cinnamon, cistus species, citronella, clary sage, clove leaf, coffee, coriander, costmary, costus root, cranberry seed, cubeb, cumin, cypress, cypriol, curry leaf, davana, dill, elecampane, eucalyptus, fennel seed, fenugreek, fir, frankincense, galangal, galbanum, geranium, ginger, goldenrod, grapefruit, henna, helichrysum, hyssop, idaho tansy, jasmine, juniper berry, lavender, laurus nobilis, ledum, lemon, lemongrass, litsea cubeba, majoram, melaleuca, melissa (lemon balm), mentha arvensis, mountain savory, mugwort, mustard, myrrh, myrtle, neem tree, neroli, nutmeg, orange, oregano, orris, palo santo, parsley, patchouli, perilla, pennroyal, peppermint, petitgain, pine, ravensara, red cedar, roman chamomile, rose, rosehip, rosemary, rosewood, sage, star anise, sandalwood, sassafras, savory, schisandra, spearmint, spikenard, spruce, tangerine, tarragon, tea tree, thyme, tsuga, turmeric, valerian, vetiver, western red cedar, wintergreen, yarrow, ylang-ylang, zeodary and parts thereof.

17. The method of claim 15 wherein the essential oils comprise castor oil.

18. The method of claim 15 wherein the encapsulating materials comprise one or more carbohydrate and one or more protein.

19. The method of claim 15 wherein the encapsulating materials comprise one or more selected from the group consisting of gelatin; monosaccharides; disaccharides; polysaccharides; glucose; fructose; sucrose; lactose; maltose; cellobiose; glycerol; starch, corn starch, wheat starch, rice starch, potato starch; water-soluble gums, carob gum, xanthan gum, carrageenan, guar gum, locust bean gum, arabinogalactans, gum Arabic, agar, and pectin; natural proteins, casein, whey protein, gelatin, gluten, soy protein, and albumin.

20. The method of claim 15 wherein the bait further comprises one or more pesticides.

21. The method of claim 15 wherein the animals comprise one or more of the group consisting of moles, voles, snakes, chipmunks, gophers, deer, rabbit, geese, dogs, cats, insects, birds, squirrels, other mammals and other reptiles.

22. A method of killing animals comprising placing one or more bait in a path of one or more animal for at least 24 hours, wherein the bait comprises one or more essential oils, one or more pesticide and one or more encapsulating materials, wherein the encapsulating material encapsulates at least one essential oil, and wherein the bait automatically releases the essential oils and pesticide over at least 30 days.

23. The method of claim 22 wherein the essential oils comprise one or more of the group consisting of oils of castor, agar, ajwain, angelica root, anise, asafoetida, balsam, basil, bergamot, bay, black pepper, buchu, birch, camphor, cannabis flower, caraway, cardamom, carrot seed, cedarwood, chamomile, calamus root, cinnamon, cistus species, citronella, clary sage, clove leaf, coffee, coriander, costmary, costus root, cranberry seed, cubeb, cumin, cypress, cypriol, curry leaf, davana, dill, elecampane, eucalyptus, fennel seed, fenugreek, fir, frankincense, galangal, galbanum, geranium, ginger, goldenrod, grapefruit, henna, helichrysum, hyssop, idaho tansy, jasmine, juniper berry, lavender, laurus nobilis, ledum, lemon, lemongrass, litsea cubeba, majoram, melaleuca, melissa (lemon balm), mentha arvensis, mountain savory, mugwort, mustard, myrrh, myrtle, neem tree, neroli, nutmeg, orange, oregano, orris, palo santo, parsley, patchouli, perilla, pennroyal, peppermint, petitgain, pine, ravensara, red cedar, roman chamomile, rose, rosehip, rosemary, rosewood, sage, star anise, sandalwood, sassafras, savory, schisandra, spearmint, spikenard, spruce, tangerine, tarragon, tea tree, thyme, tsuga, turmeric, valerian, vetiver, western red cedar, wintergreen, yarrow, ylang-ylang, zeodary and parts thereof.

24. The method of claim 22 wherein the essential oils comprise castor oil.

25. The method of claim 22 wherein the encapsulating materials comprise one or more carbohydrate and one or more protein.

26. The method of claim 22 wherein the encapsulating materials comprise one or more selected from the group consisting of gelatin; monosaccharides; disaccharides; polysaccharides; glucose; fructose; sucrose; lactose; maltose; cellobiose; glycerol; starch, corn starch, wheat starch, rice starch, potato starch; water-soluble gums, carob gum, xanthan gum, carrageenan, guar gum, locust bean gum, arabinogalactans, gum Arabic, agar, and pectin; natural proteins, casein, whey protein, gelatin, gluten, soy protein, and albumin.

27. The method of claim 22 wherein the animals comprise one or more of the group consisting of moles, voles, snakes, chipmunks, gophers, deer, rabbit, geese, dogs, cats, insects, birds, squirrels, other mammals and other reptiles.

28. A composition comprising mint oil, sodium lauryl sulfate, thyme oil white, putrescent egg solids, potassium sorbate, water, gelatin, corn starch, wheat flour, sorbic acid, potassium salt, iron oxide, lime, sodium benzoate, guar gum and castor oil.
